(19) United States
(12) Patent Application Publication
(10) Pub. No.: US 2005/0002726 A1
(43) Pub. Date: Jan. 6, 2005

(54) Toothbrush with a toothpaste container and a dosing trigger

(76) Inventor: Alberto Raul Bostal, Bahia Blanca (AR)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/828,845

(22) Filed: Apr. 20, 2004

(30) Foreign Application Priority Data
Apr. 21, 2003 (AR) P030101370

(51) Int. Cl. B43K 5/02; B05C 17/005; A46B 5/02; A47L 13/22

(52) U.S. Cl. 401/278; 401/270; 401/188 R

(57) ABSTRACT

Toothbrush presenting a toothpaste container within a hollow handle and a dosing trigger to spread the toothpaste into the bristles. This toothbrush is destined mainly for people who use this kind of utensil outside of home. Its most evident advantage is that it can be carried easily and safely. Among other advantages one may list that it is disposable, therefore, fabricated with inexpensive materials and techniques, allowing the user to buy it in any place and anytime when having it forgotten at home or in case of running out of toothpaste. The dosing trigger allows precise application of toothpaste in terms of spreading it in the right place into the bristles, and with the right amount or quantity, thus preventing the excessive use of toothpaste. Moreover, the toothpaste will always be fresh achieved this by the closing of the second valve. Finally, the retractable option enhances the transportability of this toothbrush.

### FIELD OF APPLICATION

The patent of invention here described refers to a new toothbrush with a toothpaste container and a trigger which allows the spreading of a precise dose of paste onto the bristles when operated. This toothbrush is mainly designed for people who use this kind of utensil outside of home.

### BRIEF DESCRIPTION OF PRECEDING ART

When one wishes to use a regular or conventional toothbrush outside of home, this must be carried along with a toothpaste tube. The conventional tube is deformable, so that, when one takes the lid off and presses on the opposite end of the tube, the paste comes out to later be spread on top of the bristles.

The inconveniences of such a procedure outside of home are evident: it requires more space to carry the utensils; if taken inside a pocket, different pressures may produce a spell of toothpaste staining the cloth, even worse, the lid may be lost because of its size; it requires more time, more specific places and both hands free for dosing.

On the other hand, it's very well known that disposable objets are more and more preferred by people, and the present invention must be disposed once the toothpaste is finished, giving the object a lifespan.

This problem gave place to a large number of innovations: existing patents on the subject are uncountable. In terms of establishing the state of the art, and with no intention of extinguishing the topic, three contemporary different precedents will be mentioned here.

The U.S. Pat. No. 6,390,103 B1, dated May 21^{st}, 2003, presents a set combining a toothbrush, toothpaste container, a dental floss dispenser in a single unit with a main body, a head, a refill access part, and a base. The main body has a chamber designed to contain a certain amount of toothpaste. The head part holds the bristles to clean the user's teeth. Among the bristles there is a series of minute orifices selectively communicated with the toothpaste chamber. This product allows the refill of toothpaste by means of screwing an standard toothpaste tube.

The U.S. Pat. No. 6,481,910 B1 is another invention of a toothbrush with a cylindrical handle which receives and stores toothpaste. By means of twisting its end, forces the toothpaste to move along a tubular canal toward the bristles. This end is dismountable to allow the refill.

The U.S. Pat. No. 6,533,485 B1 is also a toothbrush invention with a long, hollow handle in which a certain amount of toothpaste has been stored and with a pressuring piston like device running along a longitudinal slot. Attached to this device there is a gauge or meter designed to indicate how much toothpaste is left in the chamber. The bristles head has also got minute orifices in permanent communication with the cavity in the hollow handle.

As one can see, among the preceding art it's found that all the inventions include a toothpaste deposit within the toothbrush handle, a tube or canal connecting the toothpaste chamber with the bristles head, minute orifices among the bristles and a device that ejects the toothpaste onto the bristles. However, all these inventions present defective parts or concepts which this present invention solves.

Referring to the first example the brush is rechargeable, which means that the bristles, as well as the mounting system and materials, must be of good quality, since the brush is supposed to last several refills. This definitely increases its cost.

Identical problem presents the second example, with the addition of not being able to handle the whole dosing process with just one hand.

The third example, as the present invention shows, the toothbrush is disposable, however the quantity of toothpaste provided is small because its handle is thin. Thus, the product cost is low but its life span is short requiring the user to buy the product within shorter periods of time. This makes the product a expensive product from the user's point view.

In all known inventions, toothpaste dosing must be carefully carried out by the user, since the process required to dose the paste does not include a dosing trigger. This is not as easy to do as it seems, it requires concentration. The last end of paste chamber, by being expose to the outside environment, may have dried out or low humidity toothpaste, especially if the toothbrush hasn't been used for several days. In this case the user may apply too much pressure onto the tube to force the dry paste to come out, but once the dry paste is overcome, the fluid paste, by being under pressure, may strongly be ejected from the chamber generating an overdose or, even worse, a spill.

Also, and finally, the toothbrushes here described as previous art, have the toothpaste container always exposed to the air through the minute orifices, generating the slow drying out of the paste.

### BRIEF DESCRIPTION OF THE INVENTION

The toothbrush with a toothpaste container and a dosing trigger is characterized because it presents in its lower end a hollow handle with the interior cavity divided, by means of a sliding stop device, in an intermediate chamber, designed to contain toothpaste, and a lower chamber containing air communicated with the outside environment by a minute orifice; the superior face of this intermediate chamber shows a first valve communicating with a third chamber with varying volume formed by the interior of a hollow moving part, the trigger, and side walls extending the handle and providing a guide and a stop to the trigger; this trigger having an elastic repositioning device (spring) so that, when still, maximizes the varying volume; this first valve capable of allowing the passage of toothpaste only in the ascending direction when the pressure in the superior chamber is lower than the pressure in the intermediate chamber, which, in general terms, is substantially similar to the outside environment pressure (atmospheric pressure); such a superior chamber communicated with the tubular canal within an protruding section substantially thinner than the lower section of the handle and as extending vertically this handle, carrying this extension, in its upper end, the bristles head in which the bristles are evenly distributed over the interior vertical face of the bristles head; presenting the tubular canal an orifice with a second valve, placed this in the center of the bristles head and among them, capable this valve to allow the passage of toothpaste from such a canal to the bristles only when the pressure in the canal is higher than the ambient pressure; dosing the toothpaste when the user activates the trigger with its pointing finger, which generates an increase onto the toothpaste in the varying volume chamber and the tubular canal, opening the second valve; while deactivating the trigger, a depressurizing in the trigger chamber occurs which closes the second valve and opens the first one, suctioning toothpaste from the intermediate chamber until the trigger returns to its rest position, while the sliding stop device slides towards the trigger chamber, finally closing the first and second valves.

In another alternative, such a protruding or extending part substantially thinner than the handle is retractable, being this introduced, by means of an axial movement, from its active position, where the trigger chamber is communicated with the tubular canal, to its retracted non-operative position, where the trigger chamber is not communicated with the tubular canal within an additional cavity in the handle, presenting means of sealing the contact points between the moving retractable part and the fix parts.

Even more, as an alternative of the previous one, such a protruding or extending retractable part has a lock to fix such a part in the operative, or active, position as well as in the retracted non-operative position.

In a preferred alternative, the handle presents in its lower end a base, as a lid or cap, set in place by pressure, determining a restricted air passage from the outside environment into the minute orifice. Also having a removable cover which sets in place by means of pressure onto the upper border or surface of the handle, covering the trigger, the protruding or extending part and the bristles head.

As a possible option to all previous alternatives it presents a removable cover which sets in place by means of pressure on to the upper border of the handle, covering the trigger, the protruding or extending retractable part and the bristles head when such a part is in the retracted non-operative position.

Another option, independent from the previous, within the lower chamber inside the handle there is an elastic device (spring) which cooperates in the upper movement of the sliding stop device.

### ADVANTAGES AND OBJECTIVES FOR THE PRESENT INVENTION

The most evident advantage, already stated, is that it can be carried easily and safely. Another advantages one may list that it is disposable, therefore, fabricated with inexpensive materials and techniques, allowing the user to buy it in any place and anytime when having it forgotten at home or in case of running out of toothpaste. Moreover, dentists advice not to use toothbrushes over periods longer than three months, therefore, the use of a the disposable toothbrush doesn't result an expensive matter comparing to the use of a conventional toothbrush.

Finally, the retractable options enhance the transportability of this toothbrush. All these advantages have been taken as objectives or goals to be achieved by this invention.

Other objectives are: to allow precise application of toothpaste in terms of spreading it in the right place into the bristles, and with the right amount or quantity, thus preventing the excessive use of toothpaste, or even spilling it; to keep the toothpaste always fresh achieved this by the closing, or setting in rest position, of the second valve.

### DESCRIPTION OF THE INVENTION BY MEANS OF EXAMPLES

To develop and achieve the advantages previously listed, to which users and specialists may add more, two examples will be described with the sole purpose of illustrating the invention. Sketches or schematic drawings are attached to better illustrate the description. Since these are examples they don't entail an exclusive or limited character to protect the present patent of invention, on the contrary, they intend to explicate and illustrate the basic concepts on which the invention is based.

FIG. 1 shows a side view of a longitudinal section through the center of a non-retractable toothbrush, according to the present invention, as a first example.

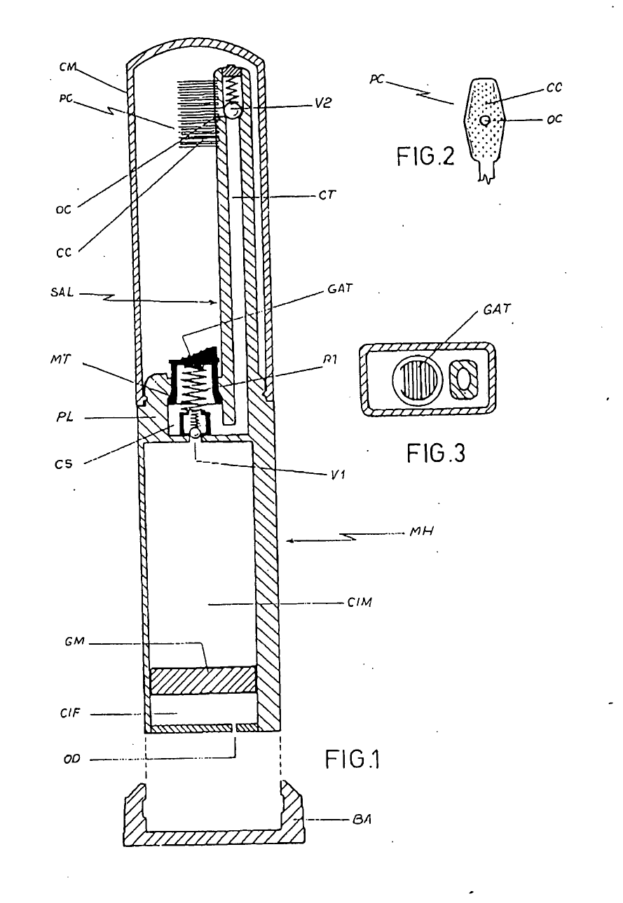

FIG. 2 shows a front view of only the bristles head, that is, facing the bristles, orthogonal from the position of the viewer in FIG. 1. FIG. 2 is valid for both examples presented in this invention.

FIG. 3 shows a top view of a transversal section above the trigger and below the bristles head, with the cover on. The dosing trigger, the tubular canal and the cover can be appreciated in the figure.

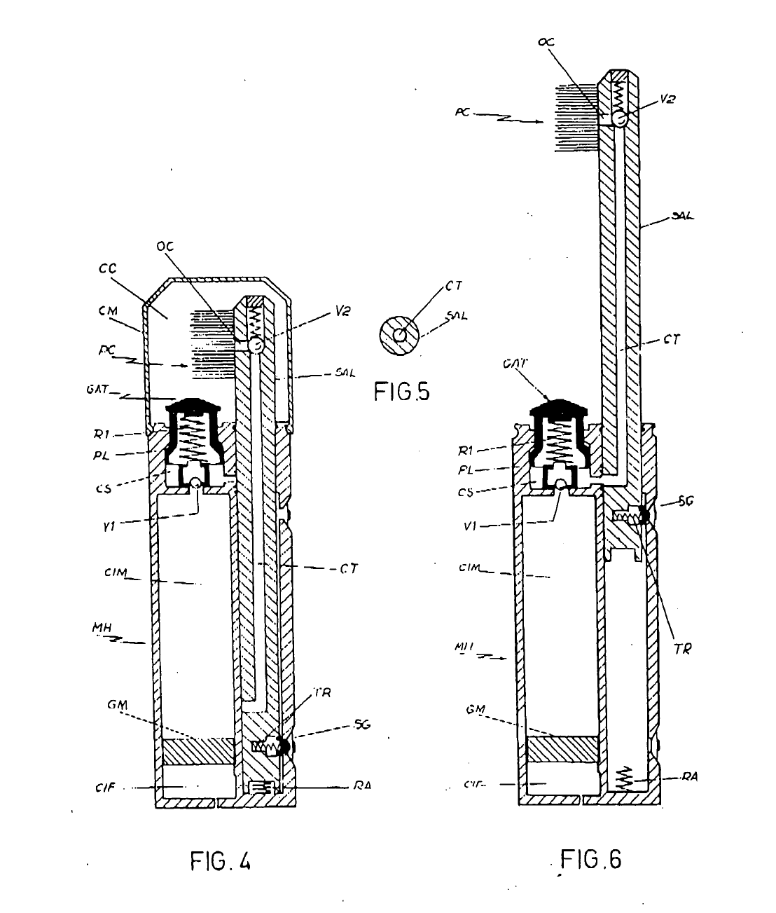

FIGS. 4 and 6 show, as a second example, a retractable toothbrush according to the present invention, showing FIG. 4 the toothbrush in its non-operative position and FIG. 6 in its “ready-to-use” position.

FIG. 5 shows a transversal section of the protruding or extending part (SAL) with the tubular canal. This Figure responds to both positions of the second example, the retractable toothbrush.

References in all figures correspond to similar elements.

About the first example, in FIG. 2, the protective cover has been removed.

As can be seen in all figures, “MH” is the hollow handle of the toothbrush, with an intermediate chamber “CIM”, or toothpaste container, assumed to be filled in the factory, and as part of the fabrication process, and a lower chamber “CIF” with air at ambient pressure, both chambers divided by a, “GM”, which moves tightly up or down along the cavity preventing the communication between both chambers. As the toothpaste is consumed the sliding stop device will move upward, mainly because of the different pressures in both chambers: the air chamber (CIF) will always have ambient pressure while the toothpaste chamber (CIM) will vary its pressure in according to whether the toothbrush is being used or not. If the pressure unbalance is not sufficient to activate the system, to overcome friction or the toothpaste resistance, as well as the valve spring “V1” mentioned later, an elastic device or spring (not illustrated) may be included in the system, not to overcome by itself all the resistances but to help balance the pressures by moving the sliding stop device (GM) upward.

In the upper en of the toothpaste chamber (CIM) one finds the valve “V1”, which allows the passage of toothpaste to the superior chamber “CS” when in the pressures decreases in it, becoming lower than the atmospheric pressure. The CS has a moving part to be activated by the user's pointing finger, while the rest of the hand holds the toothbrush handle; this part is called trigger “GAT”. In the drawn position, the trigger (GAT), by its form, sets on a surface because of the pressure deployed by the spring “R1”, which may be overcome by the pressure exercised with the finger. The CS is enclosed by side walls “PL” as if these were extensions of the perimeter walls in the handle's cavity. However, these chamber is communicated with the tubular canal inside the protruding or extending part topped by the bristles head “PC”. Here one finds the bristles “CC” on one side of the head, and, in the center of that face, and among the bristles, the orifice “OC” through which the dosed toothpaste will come out. The paste passage through this orifice (OC) is normally blocked by valve “V2”, easily overcome when the pressure in the tubular canal (CT) increases.

Obviously, to use the toothbrush, the user must first remove the cover “CM” which provides hygienic protection to the bristles head. Following, taking the toothbrush by its handle and exercising pressure onto the trigger (GAT), an overpressure is inserted in the superior chamber (CS) and the tubular canal (CT), simultaneously closing valve “V1”, and valve “V2” opens allowing a precise quantity of paste to come out among the bristles in the bristles head.

When the trigger (GAT) is released, this moves back to its rest position by means of spring “R1”, developing a low pressure in chambers “CS” and “CT”, so that “V2” closes while “V1” opens. The sliding stop device moves upward as air comes into the air chamber “CIF” through the minute orifice “OD”.

The dosing process is now finished. Now the toothbrush is ready to be used. Once used, the brush is cleansed and rinsed and the cover “CM” set in place protecting the bristles head, and the user's clothes. The toothbrush keeps its two valves closed, with no place for spills, and no risk of toothpaste's humidity evaporation. The toothbrush is ready to be used fully functional in a few hours or even few days.

For a better presentation, a base “BA” may be included to set upright the toothbrush, providing that the minute orifice “OD” stays unblocked for the air passage.

Once the toothpaste is finished, the toothbrush will be disposed.

About the second example, it only differs from the first one in that the protruding or extending part “SAL”, is retractable, and can be extended from its non-operative, retracted, position (FIG. 4) to its “ready-to-use” position (FIG. 6) by simply pulling with the fingers. It's always necessary to remove the cover “CM” first.

In order to allow a smooth movement of the retractable part “SAL” and, most important, to keep the system not exposed to air, o-rings “AS” are provided around “SAL”, both, at the hollow handle “MH” top, and around the orifice connecting “CS” and “CT” cavities. As seen in the figures, this connection is only possible in the “ready-to-use” position.

In both cases the stop position points are determined and fixed by means of a lock with spring “TR”, protected with a rubber seal “SG” in each locking point.

In fabricating the toothbrush with a toothpaste container and a dosing trigger, alternatives o modifications may be introduced, being the right of protection of the present patent of invention defined and stated by the following vindicating clauses.

Having described and illustrated the nature and main object for the present invention, as well as how this can be fabricated, it is stated to vindicate as property and exclusive right:

1. TOOTHBRUSH WITH A TOOTHPASTE CONTAINER AND A DOSING TRIGGER, characterized because it presents in its lower end a hollow handle with the interior cavity divided, by means of a sliding stop device, in an intermediate chamber, designed to contain toothpaste, and a lower chamber containing air communicated with the outside environment by a minute orifice; the superior face of this intermediate chamber showing a first valve communicating with a third chamber with varying volume formed by the interior of a hollow moving part, the trigger, and side walls extending the handle and providing a guide and a stop to the trigger; this trigger having an elastic repositioning device (spring) so that, when still, maximizes the varying volume; this first valve capable of allowing the passage of toothpaste only in the ascending direction when the pressure in the superior chamber is lower than the pressure in the intermediate chamber, which, in general terms, is substantially similar to the outside environment pressure (atmospheric pressure); such a superior chamber communicated with the tubular canal within an protruding section substantially thinner than the lower section of the handle and as extending vertically this handle, carrying this extension, in its upper end the bristles head in which the bristles are evenly distributed over the interior vertical face of the bristles head; presenting the tubular canal an orifice with a second valve, placed this in the center of the bristles head and among them, capable this valve to allow the passage of toothpaste from such a canal to the bristles only when the pressure in the canal is higher than the ambient pressure; dosing the toothpaste when the user activates the trigger with its pointing finger, which generates an increase onto the toothpaste in the varying volume chamber and the tubular canal, opening the second valve; while deactivating the trigger, a depressurizing in the trigger chamber occurs which closes the second valve and opens the first one, suctioning toothpaste from the intermediate chamber until the trigger returns to its rest position, while the sliding stop device slides towards the trigger chamber, finally closing the first and second valves.

2. TOOTHBRUSH WITH A TOOTHPASTE CONTAINER AND A DOSING TRIGGER, as vindicated in 1, characterized because such a protruding or extending part is retractable, being this introduced, by means of an axial movement, from its active position where the trigger chamber is communicated with the tubular canal, to its retracted non-operative position, where the trigger chamber is not communicated with the tubular canal within an additional cavity in the handle, presenting means of sealing the contact points between the moving retractable part and the fix parts.

3. TOOTHBRUSH WITH A TOOTHPASTE CONTAINER AND A DOSING TRIGGER, as vindicated in 1 and 2, characterized because such a protruding or extending retractable part has a lock to fix such a part in the operative, or active, position as well as in the retracted non-operative position.

4. TOOTHBRUSH WITH A TOOTHPASTE CONTAINER AND A DOSING TRIGGER, as vindicated in 1, characterized because the handle present in its base a lid or cap set in place by pressure, determining a restricted air passage from the outside environment into the minute orifice.

5. TOOTHBRUSH WITH A TOOTHPASTE CONTAINER AND A DOSING TRIGGER, as vindicated in 1, characterized because it presents a removable cover which sets in place by means of pressure on to the upper border of the handle, covering the trigger, the protruding or extending part and the bristles head.

6. TOOTHBRUSH WITH A TOOTHPASTE CONTAINER AND A DOSING TRIGGER, as vindicated in 1 and 2, characterized because it presents a removable cover which sets in place by means of pressure on to the upper border of the handle, covering the trigger, the protruding or extending retractable part and the bristles head when such a part is in the retracted non-operative position.

7. TOOTHBRUSH WITH A TOOTHPASTE CONTAINER AND A DOSING TRIGGER, as vindicated in 1, characterized because within the lower chamber, inside the handle, there is an elastic device (spring) which cooperates in the upper movement of the sliding stop device.
